(19) United States
(12) Patent Application Publication
(10) Pub. No.: US 2019/0135286 A1
(43) Pub. Date: May 9, 2019

(54) APPARATUS AND METHOD FOR AN ACCELERATION CONTROL SYSTEM

(71) Applicant: Sebastian Domingo, Opelika, AL (US)

(72) Inventor: Sebastian Domingo, Opelika, AL (US)

(21) Appl. No.: 16/136,667

(22) Filed: Sep. 20, 2018

Related U.S. Application Data
(60) Provisional application No. 62/561,155, filed on Sep. 20, 2017.

(51) Int. Cl. B60W 30/18; G01P 15/18

(52) U.S. Cl. CPC B60W 30/18027; B60W 2050/0026; G01P 15/18

(57) ABSTRACT

A system for controlling the acceleration of a vehicle comprising a programmable logic computer (PLC), a pre-programmed acceleration table that resides on the PLC, a sensor that is adapted to provide an acceleration input to the PLC, and a powertrain that is adapted to receive an output from the PLC. The PLC is adapted to control the powertrain in response to the acceleration input from the sensor by comparing the acceleration input with the pre-programmed acceleration table. A method for controlling the acceleration of a vehicle further comprising controlling the powertrain in response to the acceleration input from the sensor.

### CROSS-REFERENCES TO RELATED APPLICATIONS/PATENTS

This application relates back to and claims the benefit of priority from U.S. Provisional Application for Patent Ser. No. 62/561,155 titled “GMeter Assisted Tuning System” and filed on Sep. 20, 2017.

### FIELD OF THE INVENTION

This invention relates to the vehicle racing industry and more particularly is the implementation of a collection of novel vehicle forward acceleration tuning and control algorithms believed to be unique yet widely applicable in the vehicle racing industry enabling improved performance of racing vehicles. This Apparatus and Method is referred to by the inventor as the “GMeter Assisted Tuning System” or GATS.

### BACKGROUND AND DESCRIPTION OF THE PRIOR ART

When drag racing a vehicle such as a boat, plane, motorcycle, car, truck etc., tuning for maximum acceleration is very technical and hard for many people to understand. Such tuning usually requires many sensors to accomplish and lots of time which is very expensive. Most require professional tuners to accomplish this task. Normal sensors used are drive shaft rpm, engine rpm and acceleration.

Average Velocity (v) is expressed in distance traveled (D) per unit time (t) or v=D/t and Acceleration (a) is expressed as the rate of increase in velocity (V) per unit time or a=V/t. If the acceleration is not constant over the time period of interest, as in racing, then final velocity (V) can be expressed as the product of average acceleration (a) and elapsed time or V=aT and total racing distance D=aT²/2 or T=\sqrt{2D/a}. Since the distance D to be traveled during a race is given and the object of racing is the minimization of elapsed time T, optimal racing is simply a matter of maximizing acceleration of the given vehicle at each instant in time during the race. Of course, there are many factors to be considered in producing the maximum average of acceleration. One cannot simply apply all available torque to the drive wheels since the amount of forward torque that can be transferred through the interface of the drive wheel and track surface changes dynamically with temperatures and conditions of the tire and each segment of track. Maximum performance with respect to average acceleration occurs as long as an increase in drive system power input results in an increase in average forward acceleration and does not result in a loss of directional control of the vehicle.

In prior art, the primary feedback mechanism used has been wheel spin or slippage as determined by a variety of methods including comparison of the drive wheel RPM to the RPM of a non-driven wheel, typically one of the front wheels of the vehicle. Such limited control is reactive and does not directly anticipate the probability of spin or lift based on the vehicle's speed or position on the track.

In addition, conventional control systems suffer from one or more of the following disadvantages: they take too much time and labor to tune; they are too expensive to tune; they are too complex to tune; they do not establish control algorithms; they produce slower pass times; they produce inconsistent pass times; they do not eliminate or sufficiently minimize tire to track slippage or spin; they do not eliminate or sufficiently minimize front wheel lift; they do not dynamically control acceleration; they do not anticipate the probability of tire to track slippage or spin based on the vehicle's speed or track position; they do not anticipate the probability of lift based on the vehicles speed or track position; they do not automatically increase or decrease the (i) pressure to the top of the waste gate(s) of a turbo system, (ii) the pressure to the top of a blow-off valve of a supercharger, (iii) the duty cycle of nitrous or fuel solenoids, (iv) the pressure to the control port of a clutch assembly, (v) the duty cycle of a solenoid that controls the transmission fluid, (vi) the duty cycle of a solenoid that controls fluid (vii) proportional output that is connected to an engine control unit in order to control the ignition timing and/or the fuel pressure and/or the boost pressure; they do not produce a pre-programmed acceleration curve; and they do not produce a pre-programmed lift graph.

It would be desirable, therefore, if an apparatus and method for a material control device could be provided that would not take too much time and labor to tune; that would not be too expensive to tune; that would not be too complex to tune; that would establish control algorithms; that would produce faster pass times; that would produce consistent pass times; that would eliminate or sufficiently minimize tire to track slippage or spin; that would eliminate or sufficiently minimize front wheel lift; that would dynamically control acceleration; that would anticipate the probability of tire to track slippage or spin based on the vehicle's speed or track position; that would anticipate the probability of lift based on the vehicles speed or track position; that would automatically increase or decrease the (i) pressure to the top of the waste gate(s) of a turbo system, (ii) pressure to the top of a blow-off valve of a supercharger, (iii) duty cycle of nitrous or fuel solenoids, (iv) pressure to the control port of a clutch assembly, (v) duty cycle of a solenoid that controls the transmission fluid, (vi) duty cycle of a solenoid that controls fluid (vii) proportional output that is connected to an engine control unit in order to control the ignition timing and/or the fuel pressure and/or the boost pressure; that would produce a pre-programmed acceleration curve; and that would produce a pre-programmed lift graph.

### Advantages of the Preferred Embodiments of the Invention

Accordingly, it is an advantage of the preferred embodiments of the invention claimed herein to provide an apparatus and method for a system for controlling the acceleration of a vehicle that does not take too much time and labor to tune; that is not too expensive to tune; that is not too complex to tune; that establishes control algorithms; that produces faster pass times; that produces consistent pass times; that eliminates or sufficiently minimizes tire to track slippage or spin; that eliminates or sufficiently minimizes front wheel lift; that dynamically controls acceleration; that anticipates the probability of tire to track slippage or spin based on the vehicle's speed or track position; that anticipates the probability of lift based on the vehicles speed or track position; that automatically increases or decreases the (i) pressure to the top of the waste gate(s) of a turbo system, (ii) pressure to the top of a blow valve of a supercharger, (iii) duty cycle of nitrous or fuel solenoids, (iv) pressure to the control port of a clutch assembly, (v) duty cycle of a solenoid that controls the transmission fluid, (vi) duty cycle of a solenoid that controls fluid (vii) proportional output that is connected to an engine control unit in order to control the ignition timing and/or the fuel pressure and/or the boost pressure; that produces a pre-programmed acceleration curve; and that produces a pre-programmed lift graph.

Additional advantages of the preferred embodiments of the invention will become apparent from an examination of the drawings and the ensuing description.

### EXPLANATION OF THE TECHNICAL TERMS

As used herein, the term “powertrain” means a device, mechanism, assembly, machine, or combination thereof adapted to propel a vehicle as defined herein below. The term “powertrain” includes, without limitation, gasoline engines, diesel engines, hybrid engines, electric motors, batteries, manual transmissions, automatic transmissions, drive shafts, differentials, wheels, tracks, propellers, and the like.

As used herein, the term “sensor” means an instrument (or a component of an instrument) that converts an input signal into a quantity that is measured by another instrument (or another component of the instrument) and changed into a useful signal for an information-gathering system. The term “sensor” includes, without limitation, thermal sensors, electromagnetic sensors, mechanical sensors, motion sensors, and the like.

As used herein, the term “vehicle” means a self-propelled device, mechanism, assembly, machine or other form of conveyance that is designed to transport people and/or goods. The term “vehicle” includes, without limitation, motorcycles, automobiles, vans, trucks, buses, trains, watercraft, aircraft, and the like.

### SUMMARY OF THE INVENTION

The apparatus of the invention comprises a system for controlling the acceleration of a vehicle. The preferred system comprises a programmable logic computer (PLC), a pre-programmed acceleration table that resides on the PLC, a sensor that is adapted to provide an acceleration input to the PLC, and a powertrain that is adapted to receive an output from the PLC. In the preferred system, the PLC is adapted to control the powertrain in response to the acceleration input from the sensor by comparing the acceleration input with the pre-programmed acceleration table.

The method of the invention comprises a method for controlling the acceleration of a vehicle. The preferred method comprises providing a system for controlling the acceleration of a vehicle. The preferred system comprises a programmable logic computer (PLC), a pre-programmed acceleration table that resides on the PLC, a sensor that is adapted to provide an acceleration input to the PLC, and a powertrain that is adapted to receive an output from the PLC. In the preferred system, the PLC is adapted to control the powertrain in response to the acceleration input from the sensor by comparing the acceleration input with the pre-programmed acceleration table. The preferred method further comprises controlling the powertrain in response to the acceleration input from the sensor.

### BRIEF DESCRIPTION OF THE DRAWINGS

The presently preferred embodiments of the invention are illustrated in the accompanying drawings, in which like reference numerals represent like parts throughout, and in which:

FIG. 1 is a schematic flow chart of the accelerometer input signals received by the apparatus and the Digital Signal Processing (DSP) of longitudinal acceleration, inclination, and their derivatives;

FIG. 2 is a schematic flow chart of the Acceleration Processing Section;

FIG. 3 is a schematic flow chart of the Lift Processing Section;

FIG. 4 is a schematic flow chart of the Deceleration derivative Processing Section;

FIG. 5 is a schematic flow chart of the combined signal output and logic Section;

FIG. 6 is a flow chart of the GATS Iterative Tuning Method.

### DESCRIPTION OF THE PREFERRED EMBODIMENTS OF THE INVENTION

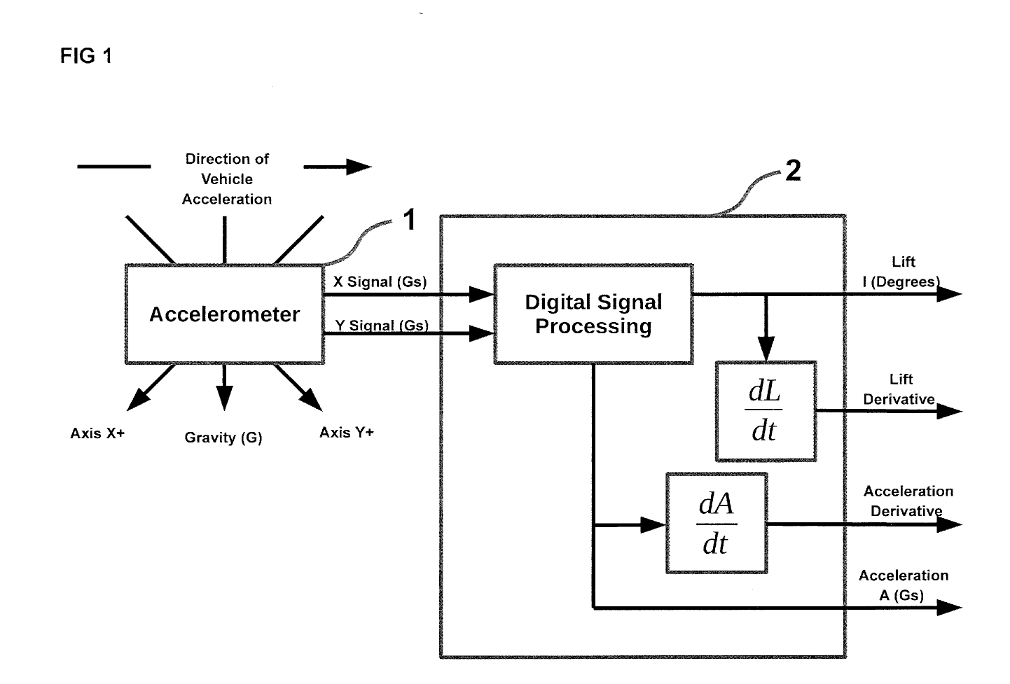

Referring now to the drawings, the preferred embodiment of the material control device in accordance with the present invention is illustrated by FIGS. 1 through 6. As shown in FIGS. 1-6, the preferred embodiments of the invention comprise a unique collection of methods for analyzing, processing, prioritizing and combining historical and real time data collected from an on-board accelerometer into an optimal vehicle power delivery strategy using rules programmed by the user. More particularly, the preferred embodiments of the invention comprise a system for controlling the acceleration of a vehicle. The preferred system comprises a programmable logic computer (PLC), a pre-programmed acceleration table that resides on the PLC, a sensor that is adapted to provide an acceleration input to the PLC, and a powertrain that is adapted to receive an output from the PLC. In the preferred system, the PLC is adapted to control the powertrain in response to the acceleration input from the sensor by comparing the acceleration input with the pre-programmed acceleration table. In one preferred embodiment of the invention the sensor comprises an accelerometer or a two-axis accelerometer. In another preferred embodiment of the invention the system further comprises a pre-programmed lift table that resides on the PLC and the sensor is adapted to provide a lift input to the PLC. Also in this preferred embodiment, the PLC is adapted to control the powertrain in response to the lift input from the sensor by comparing the lift input with the pre-programmed lift table. In yet another preferred embodiment of the invention, the system further comprises a pre-programmed deceleration table that resides on the PLC and the sensor is adapted to provide a deceleration input to the PLC. Also in this preferred embodiment of the invention, the PLC is adapted to control the powertrain in response to the deceleration input from the sensor by comparing the deceleration input with the pre-programmed deceleration table.

Referring now to FIG. 1, the preferred embodiment of the invention utilizes a 2-axis accelerometer (FIG. 1, number 1) mounted in the vertical-longitudinal plane with axes positioned at 45 degrees relative to the direction of gravitational acceleration. The two outputs are calibrated in Gs and provide real-time information containing the encoded values of forward acceleration and rotation about an imaginary lateral axis that is interpreted as lift.

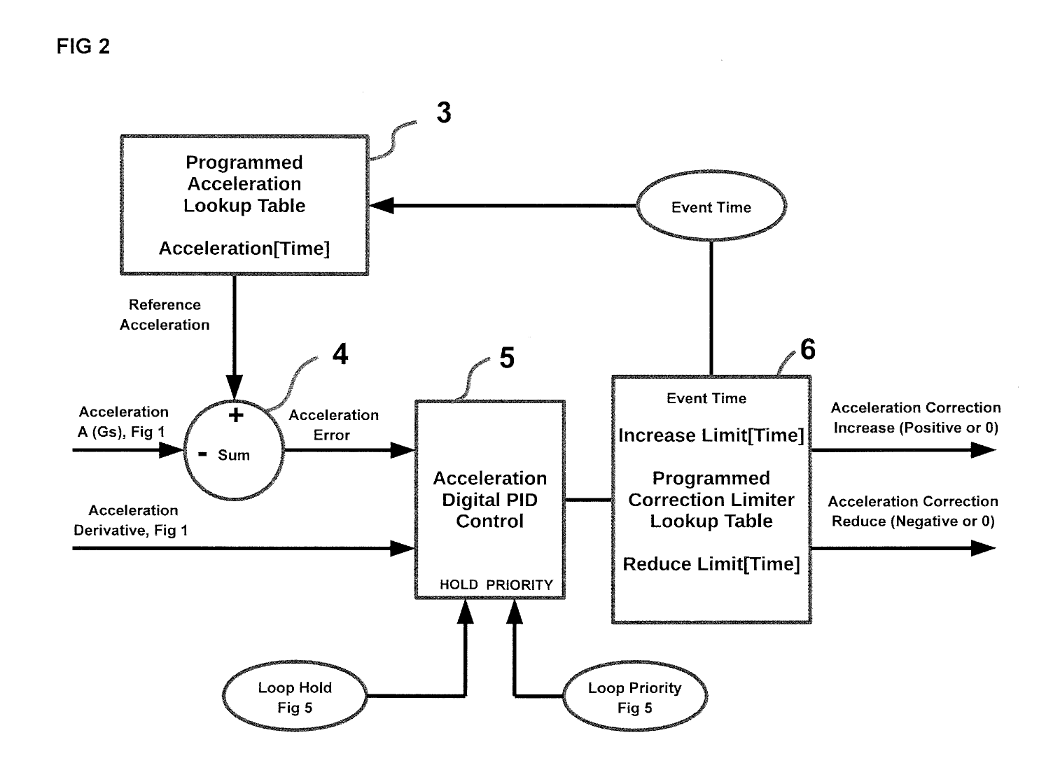

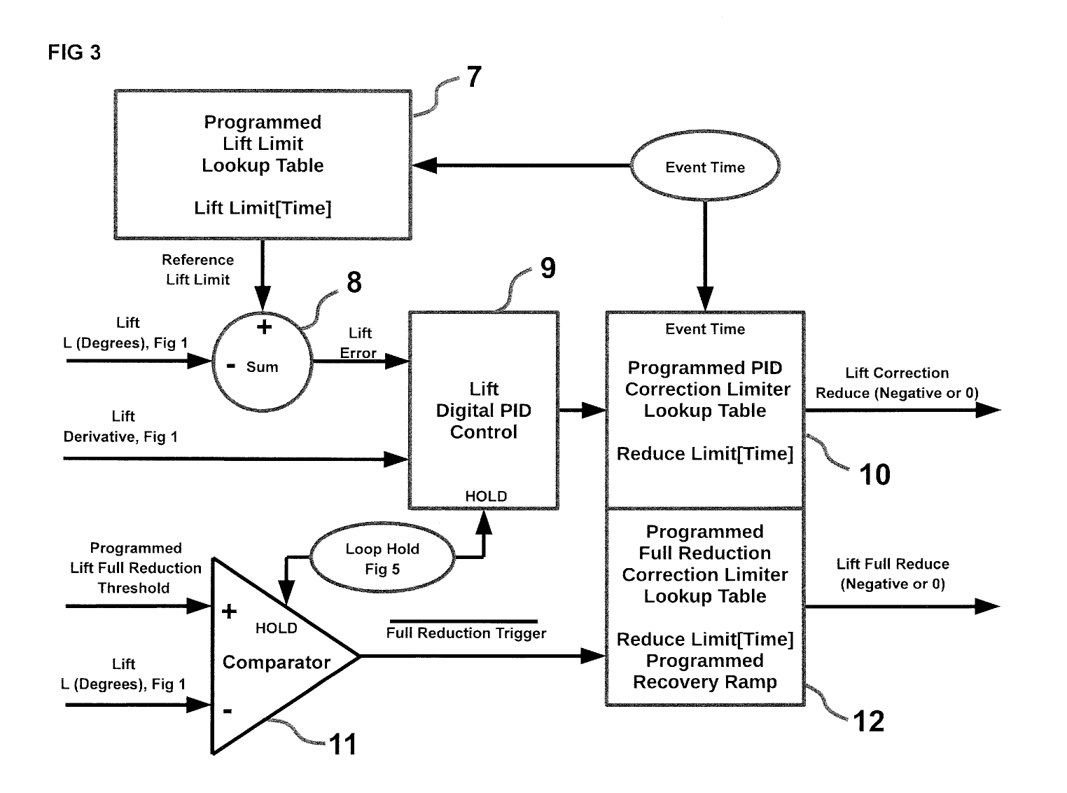

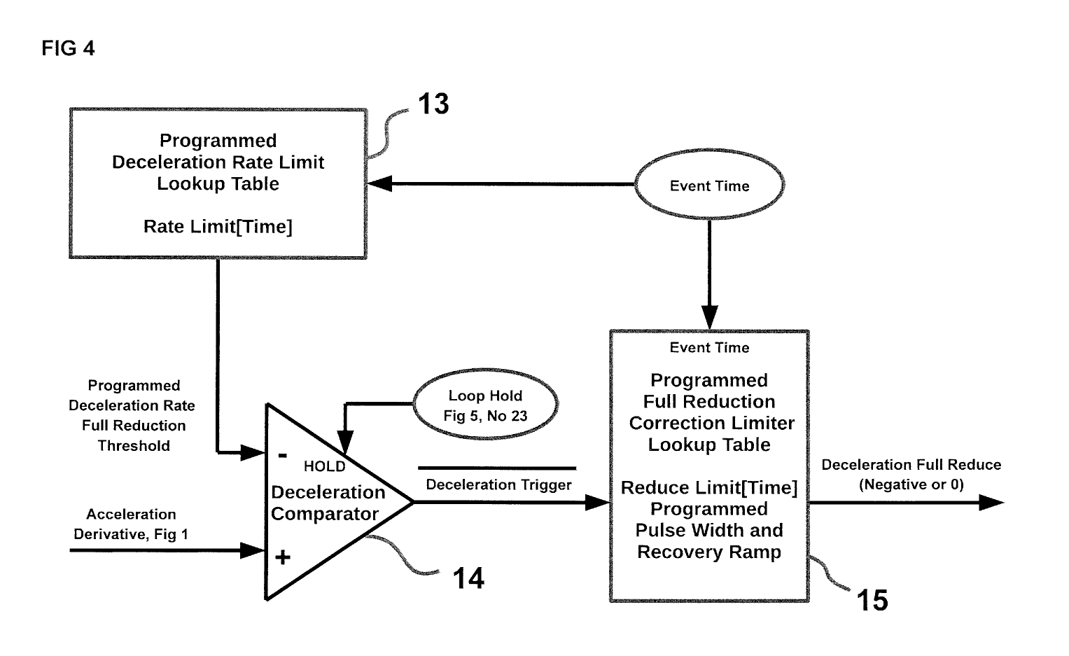

In this application, it is difficult to detect the lift angle in the presence of gravity, longitudinal acceleration perpendicular to gravity, and vehicle vibrations and lost motion. A very specialized algorithm is executed in the Digital Signal Processing (DSP) block (FIG. 1, number 2) in order to achieve a useful level of accuracy of lift and forward acceleration and deceleration. The DSP block also calculates the derivatives of lift and the acceleration with respect to time for processing in the Acceleration Processing section (FIG. 2) and the Incline Processing section (FIG. 3) and in the Deceleration Processing section (FIG. 4).

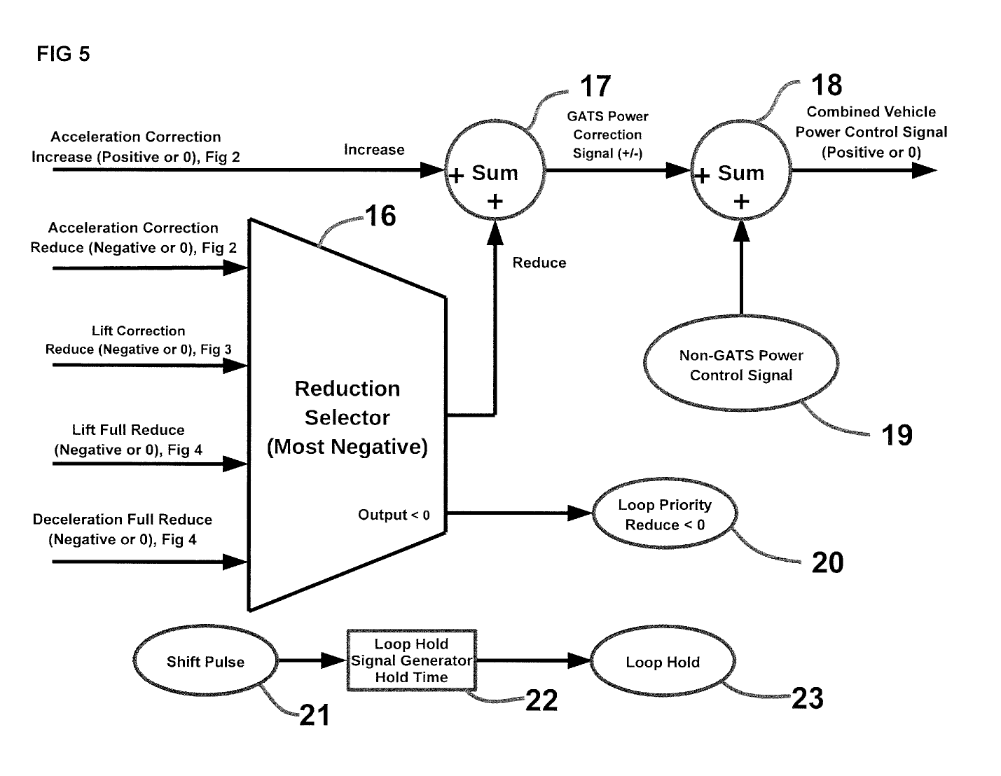

The Acceleration Lookup Table (FIG. 2, number 3) takes the event elapsed time as an input and interpolates the desired vehicle reference acceleration for that point in time from a pre-programmed table specifically created for the particular racing vehicle of interest. The real-time acceleration is subtracted (FIG. 2, number 4) from the calculated reference acceleration to produce an acceleration error signal to be processed by the Acceleration Proportional, Integral, and Derivative (PID) block (FIG. 2, number 5). It is often necessary to delay the start of or to prevent over-correction of the Acceleration PID block. The Correction Limiter (FIG. 2, Number 6) implements a pre-programmed table of power increase and decrease correction limits with respect to elapsed time. After applying those limits, the resulting correction value is provided to the Combinatorial Section (FIG. 5) as a positive increase plus a negative decrease signal.

Similarly, the Lift Limit Lookup Table (FIG. 3, number 7) takes the event elapsed time as an input and interpolates the desired vehicle reference lift limit for that point in time from a pre-programmed table specifically created for the particular racing vehicle of interest. The real-time lift measurement subtracted (FIG. 3, number 8) from the lift reference signal produces a lift error signal to be processed by the Lift PID block (FIG. 3, number 9). It is often necessary to delay the start of or to prevent over-correction of the Lift PID block. The lift Correction Limiter (FIG. 3, Number 10) implements a pre-programmed table of power reduce correction limits versus elapsed time. After applying those limits, the resulting correction value is provided to the Combinatorial Section (FIG. 5) as a negative decrease signal. It should be noted that the Lift and Acceleration PID and Correction Limiting blocks function identically, but in usual practice there is no benefit gained from increasing lift, so the lift Increase Limits are fixed at 0 in the preferred embodiment and not shown here.

In practice, it is sometimes difficult to reduce power fast enough to adequately compensate for excessive lift, so an optional “Lift Full Reduction Threshold” comparator (FIG. 3, number 11) is used to react more quickly than the slower Lift PID block. If the Lift exceeds the pre-programmed threshold, it triggers the Full Reduction Limiter (FIG. 3, number 12) to supply the correction programmed for that point in time to the Combinatorial Section (FIG. 5). The Full Reduction Limiter may also be pre-programmed with a starting recovery absolute value and ramp time if desired to give the user the ability to re-apply drive power slowly after the limiting event. The absolute value is converted to a correction value that is provided to the Combinatorial Section (FIG. 5) as a decrease signal that is ramped to zero (0) over the desired ramp time.

Similarly, the Deceleration Rate Limit Lookup Table (FIG. 4, number 13) takes the event elapsed time as an input and interpolates the desired vehicle reference Deceleration limit for that point in time from a pre-programmed table specifically created for the particular racing vehicle of interest. The reference threshold is compared to the acceleration derivative by the Deceleration Rate comparator (FIG. 4, number 14). Such rapid decreases, when occurring during particular time segments of an event with no corresponding explained reason, have been found to indicate that a large portion of the forward torque applied to the track interface has been suddenly redirected or lost, typically due to excessive heating of the interface due to excessive wheel spinning. The appropriate counter-action in response to such events is an immediate reduction in powertrain input power. If the rate of deceleration exceeds the pre-programmed threshold, it triggers the full reduction limiter (FIG. 4, number 15) to supply the full reduction limit programmed for that point in time to the Combinatorial Section (FIG. 5). The Deceleration Full Reduction Limiter may also be pre-programmed with a minimum reduction time (pulse width) and desired ramp time if desired to give the user the ability to re-apply drive power slowly.

Successful control of the vehicle performance involves a number of disparate parameters, triggers and independent feedback loops. Typically the Acceleration Processing Section is allowed to increase and (optionally) reduce power, where the Lift Processing Section is allowed only to reduce power. In addition, parameters may be of interest only at particular points in the event. In the preferred embodiment, user control over permitted correction limits at various points in elapsed time is provided by the Programmed Correction Limiter Lookup Tables (FIG. 2, number 6; FIG. 3 numbers 10 and 12; FIG. 4, number 15) indexed by elapsed time for each correction source. Note that an increase limit may be 0 if appropriate, meaning that the corresponding correction source cannot increase the output, but can reduce the output if the corresponding reduce limit is less than 0. Conversely, the source will only be allowed to increase if the increase limit is greater than 0 and the corresponding reduce limit is 0. If both limits are non-zero, the corresponding source can increase and reduce the output.

If any power correction source is demanding a power reduction, the logic signal “Loop Priority” (FIG. 5, number 20) is asserted to prevent any correction source from simultaneously increasing the power demand. For instance, the Acceleration PID Control (FIG. 2, number 5) may request an increase in power that is “held” by the Deceleration Section (FIG. 5) demanding a reduction. All PID loops and comparators are allowed to continue calculating negative correction values as needed, and can indeed take control of the correction if they have the greatest demand for power reduction.

Significant expected perturbations could cause unwarranted power reductions. For instance, gear shifts may generate a short deceleration and an acceleration peak. In order to prevent such short events from triggering an anomalous reaction the user may program the Loop Hold Signal Generator Hold Time (FIG. 5, number 22). This signal prevents the Deceleration Comparator (FIG. 4, number 14) from detecting deceleration resulting from power reduction. At the same time, other PID loops and comparators (FIG. 3, numbers 9 and 11, and FIG. 2, Number 5) are also held in place to prevent their reaction to shift events.

At each discrete DSP time sample, the most negative correction requested is then connected via the Reduction Selector (FIG. 5, number 16) to the correction summing node (FIG. 5, number 17) to be added with any sources that could be requesting a power increase. The final summing node (FIG. 5, number 18) then adds the composite GATS correction signal to any additional programmed power levels that are not designated GATS.

The preferred embodiment supports the following factors as criteria for enabling each loop, but the method is by no means limited only to the following factors. Indeed, as yet undiscovered criteria could be used simply by combining the criteria into a multiple input Boolean logic block. Of course, the selection of criteria may be the same or different for each loop.
a) The race may be in the pre-launch staging mode.
b) The vehicle transbrake may be applied or not.
c) The vehicle is in the event execution mode with the elapsed time counting.
d) The vehicle and event may be interrupted.
e) The vehicle may be recovering from an interruption.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

### Tuning Method

The method of the invention comprises a method for controlling the acceleration of a vehicle. The preferred method comprises providing a system for controlling the acceleration of a vehicle. The preferred system comprises a programmable logic computer (PLC), a pre-programmed acceleration table that resides on the PLC, a sensor that is adapted to provide an acceleration input to the PLC, and a powertrain that is adapted to receive an output from the PLC. In the preferred system, the PLC is adapted to control the powertrain in response to the acceleration input from the sensor by comparing the acceleration input with the pre-programmed acceleration table. The preferred method further comprises controlling the powertrain in response to the acceleration input from the sensor. In another preferred embodiment of the invention, the method further comprises controlling the powertrain in response to the lift input.

The software GUI (Graphical User Interface) of this invention supports an efficient iterative method for generation of appropriate tables for a subject vehicle. Firmware supports a special test mode for the firmware processing of each of the three major control parameters Acceleration (ACCEL), Lift Limiting (LIFT), and Deceleration Limiting (DECEL).

Of particular interest during tuning are three data logging channels associated with each of the GATS processes, the Boost Pressure or Nitrous Duty Cycle the transmission shift signal, and the start of race indicators:
a) Acceleration
b) Accel Target
c) Accel Correction
d) Lift
e) Lift Limit
f) Lift Correction
g) Decel Rate
h) Decel Limit
i) Decel Correction
j) Shift Input
k) Primary Timer Status
l) Trans-brake Input Status
m) The actual boost pressure control signal (for non-nitrous vehicles)
n) The actual Nitrous Solenoid on-time percentage (for nitrous vehicles)

With the GATS system in test mode and the aforementioned channels logged, the vehicle is accelerated over the length of the track to collect one or more examples of actual acceleration performance data that is representative of an actual race.

The representative acceleration data collected from the invention is then used to adjust the acceleration table by overlaying the actual acceleration data onto the graphical display of the table to be programmed. The acceleration data from the previous pass must be aligned in elapsed time with the programmed table elapsed time. The GUI supports selection of appropriate logged channels to overlay onto the tables as a reference so the tables can be easily adjusted by dragging the table points in relation to the reference data. The desired target acceleration table curve should be drawn just slightly greater than the overlaid acceleration curve from the actual vehicle test pass. Where actual acceleration data shows dips and peaks in acceleration, the desired acceleration curve being drawn should smooth those variations so the net average desired acceleration is greater than the previous vehicle performance, but not unrealistically so. It is necessary that the vehicle be capable of achieving the desired target performance.

Since there is a natural drop in acceleration when the car shifts it is advisable to have the controller hold in place and suppress making power adjustments during gear shifts. Based on the length of the acceleration disturbance observable in the overlay, the “Shift Blanking Pulse Width” is set to a value sufficient to prevent unwanted correction attempts. A typical value for the width of this blanking pulse is 300 milliseconds.

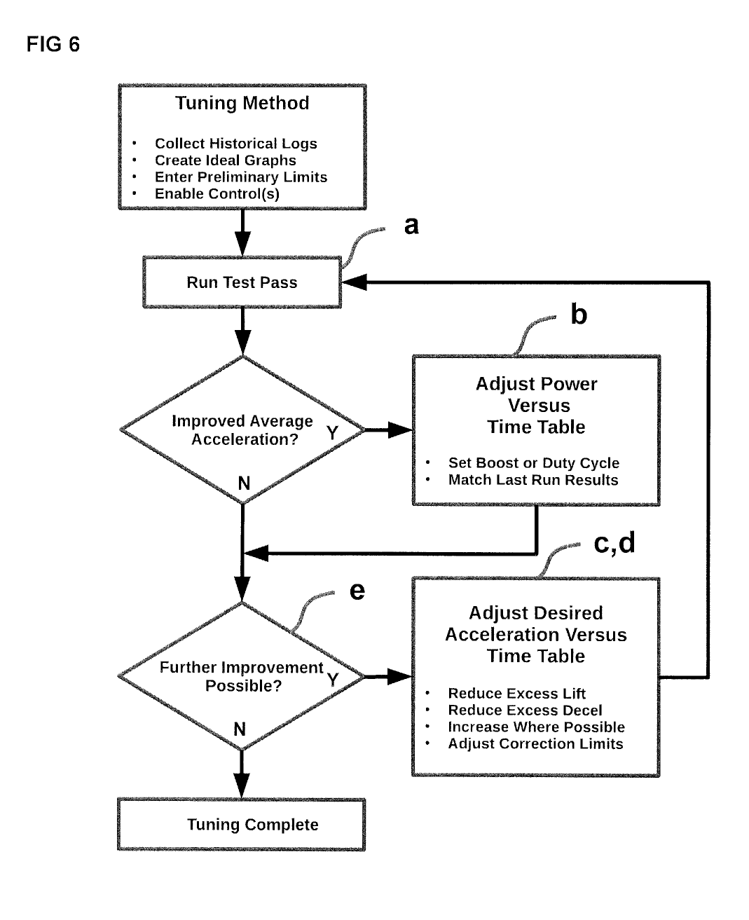

Finally, the acceleration control table is enabled to actually control the power train input and the iterative tuning process (FIG. 6) continues as follows:
a) A pass is made and the logged data is overlaid on the graphical desired acceleration table.
b) If the results are as expected, the resulting logged power train control data (after GATS real-time adjustment) can be overlaid on a “power vs time” programming table (Boost Pressure or Nitrous Solenoid On Time) that will then reproduce the results of the GATS-controlled pass without the need for active GATS correction. This allows the range of active GATS adjustment for acceleration to then be minimized or finally eliminated on subsequent passes.
c) The desired acceleration table is then modified wherever opportunities to improve performance are seen to exist in the overlaid acceleration log from the previous pass. The desired acceleration table can be increased at points where lift and/or slippage are not at issue.
d) The desired acceleration table must be reduced wherever evidence of lift and/or slippage that reduces the acceleration is present from the previous pass.
e) Steps a-d are repeated until no further improvements can be made in elapsed time and stability by fine tuning the desired acceleration table.

Once the optimal acceleration curve is determined and the “power vs time” programming table has been adjusted, The GMeter Assisted Tuning Method has been successfully applied and the vehicle performance will show a marked improvement. At this point, the corrections made by active GATS should be minimal and GATS acceleration control can be left active or returned to the “Test Mode” to monitor the vehicle behavior and suggest corrective action based on data from subsequent passes.

There are a number of secondary fail-safe limits and thresholds supported by the GUI and firmware that can be applied as-needed to provide mechanisms to recover in real-time from tuning errors and mechanical variations that occur from track to track. The apparatus providing these functions are described in the detailed description. The GUI provides support for efficient determination of various thresholds and limits which can be utilized in conjunction with the Programmed Acceleration Table during tuning and/or actively during a race. In the present invention these currently are (but not limited to):
a) Programmed Lift Limiting Table for active PID control of excessive lift and can be programmed by overlaying the logged lift on the Lift Limiting Table.
b) Programmed Lift Full Reduction Threshold. This is a trigger threshold where power will be rapidly reduced by a programmed maximum value and then to recover in a ramp over a specified period of time from a specified starting limit.
c) Programmed Deceleration Rate Limiting Table provides a threshold for comparison of the Deceleration Rate. If the rate exceeds the threshold for the table point, a maximum reduction in power will be triggered and held for a programmed pulse width before recovering in a ramp over the specified ramp time. This table can also be programmed by overlaying the logged Decel Rate on the Deceleration Limiting Table.

It is also contemplated within the scope of the invention that part or all of this tuning method may be accomplished in an automated fashion or in a fashion that evolves as software user interfaces do.

The present invention seeks to control the powertrain input power of potentially any type of vehicle based on the difference between the measured vehicle acceleration and a programmed table of desired vehicle acceleration with respect to elapsed time or distance of the race. The programmed table can be any arbitrary set of acceleration and elapsed time pairs selected by the user based on previous experience and knowledge of the vehicle and track. For instance, it could simply be the historical curve of acceleration vs elapsed time from a log of the vehicles best race. The difference signal is processed in a firmware control loop to produce a power correction signal to increase (if need be) the power control signal(s) so that the vehicle acceleration meets or exceeds the target acceleration curve that the user programmed. If the measured value is under the target the power control correction signal(s) will increase unless such increase would exceed a maximum limit set by the user. If the measured value goes over the target then the power control correction signal(s) will hold in place or decrease unless such decrease would exceed a minimum limit set by the user. Of course, control of powertrain input power based solely on historic information is insufficient for successful forward acceleration control in that a programmed increase in power may result only in a reduction of forward torque transmitted through the track interface or result in an unsafe or uncontrollable vehicle orientation, especially inclination. To address this the power control signal(s) can be further modulated in real time during the race using a number of additional variables and rules selected by the user.

In a more advanced form of vehicle forward acceleration control, a second pre-programmed table of allowable vehicle incline with respect to elapsed time or distance of the race can be used to prevent the vehicle from flipping over or veering off track. The incline angle of the vehicle is also calculated using math and compared to this curve. As long as the incline is less than that allowed, priority of the power control is given to the desired acceleration process loop. If the incline angle is greater than that allowed then priority is taken from the desired acceleration process and the drive system power input limited or reduced.

In yet a more advanced form of control, the user can program a table of allowable rates of change in deceleration (the first derivative of deceleration) with respect to vs elapsed time or distance of the race. The derivative of deceleration of the vehicle is also calculated using math and compared to this curve. As long as the derivative is less than that allowed, priority of the power control is given to the desired acceleration process loop. If the value is greater than that allowed then priority is again taken from the desired acceleration process and the drive system input power is limited or reduced to prevent the vehicle from spinning.

There are many potential ways to use the described invention. The method of combining the resultant control signals and their prioritization strategy. The number of feedback variables and comparisons (only 3 are mentioned) and combinations is unlimited. Indeed, one of the unique aspects of this invention is its flexibility in that respect. In the preferred embodiment, top priority is given the power correction source requesting the greatest reduction in power. If none request a reduction in power, then the desired acceleration process takes precedence and is allowed to increase power within additional programmed constraints.

Although this description contains many specifics, these should not be construed as limiting the scope of the invention but as merely providing illustrations of some of the presently preferred embodiments thereof, as well as the best mode contemplated by the inventors of carrying out the invention. The invention, as described herein, is susceptible to various modifications and adaptations, and the same are intended to be comprehended within the meaning and range of equivalents of the appended claims.

What is claimed is:

1. A system for controlling the acceleration of a vehicle, said system comprising:
(a) a programmable logic computer (PLC);
(b) a pre-programmed acceleration table, said pre-programmed acceleration table residing on the PLC;
(c) a sensor, said sensor being adapted to provide an acceleration input to the PLC;
(e) a powertrain, said powertrain being adapted to receive an output from the PLC;
wherein the PLC is adapted to control the powertrain in response to the acceleration input from the sensor by comparing the acceleration input with the pre-programmed acceleration table.

2. The system of claim 1 wherein the sensor comprises an accelerometer.

3. The system of claim 1 wherein the sensor comprises a two-axis accelerometer.

4. The system of claim 1 further comprising a pre-programmed lift table, said pre-programmed lift table residing on the PLC.

5. The system of claim 4 wherein the sensor is adapted to provide a lift input to the PLC.

6. The system of claim 5 wherein the PLC is adapted to control the powertrain in response to the lift input from the sensor by comparing the lift input with the pre-programmed lift table.

7. The system of claim 1 further comprising a pre-programmed deceleration table, said pre-programmed deceleration table residing on the PLC.

8. The system of claim 7 wherein the sensor is adapted to provide a deceleration input to the PLC.

9. The system of claim 8 wherein the PLC is adapted to control the powertrain in response to the deceleration input from the sensor by comparing the deceleration input with the pre-programmed deceleration table.

10. A system for controlling the acceleration of a vehicle, said system comprising:
(a) a programmable logic computer (PLC);
(b) a pre-programmed acceleration table, said pre-programmed acceleration table residing on the PLC;
(c) a pre-programmed lift table, said pre-programmed lift table residing on the PLC;
(d) a pre-programmed deceleration table, said pre-programmed deceleration table residing on the PLC;
(c) a two-axis accelerometer, said two-axis accelerometer being adapted to provide an acceleration input, a lift input, and a deceleration input to the PLC;
(e) a powertrain, said powertrain being adapted to receive an output from the PLC;
wherein the PLC is adapted to control the powertrain in response to the acceleration input, the lift input, and the deceleration input from the two-axis accelerometer by comparing the acceleration input with the pre-programmed acceleration table, comparing the lift input with the pre-determined lift table, and comparing the deceleration input with the pre-determined deceleration table.

11. A method for controlling the acceleration of a vehicle, said method comprising:
(a) providing a system for controlling the acceleration of a vehicle, said system comprising:
(i) a programmable logic computer (PLC);
(ii) a pre-programmed acceleration table, said pre-programmed acceleration table residing on the PLC;
(iii) a sensor, said sensor being adapted to provide an acceleration input to the PLC;
(iv) a powertrain, said powertrain being adapted to receive an output from the PLC;
wherein the PLC is adapted to control the powertrain in response to the acceleration input from the sensor by comparing the acceleration input with the pre-programmed acceleration table;
(b) controlling the powertrain in response to the acceleration input from the sensor.

12. The method of claim 11 wherein the sensor comprises an accelerometer.

13. The method of claim 11 wherein the sensor comprises a two-axis accelerometer.

14. The method of claim 11 further comprising a pre-programmed lift table, said pre-programmed lift table residing on the PLC.

15. The method of claim 14 wherein the sensor is adapted to provide a lift input to the PLC.

16. The method of claim 15 wherein the PLC is adapted to control the powertrain in response to the lift input from the sensor by comparing the lift input with the pre-programmed lift table.

17. The method of claim 11 further comprising a pre-programmed deceleration table, said pre-programmed deceleration table residing on the PLC.

18. The method of claim 17 wherein the sensor is adapted to provide a deceleration input to the PLC.

19. The method of claim 18 wherein the PLC is adapted to control the powertrain in response to the deceleration input from the sensor by comparing the deceleration input with the pre-programmed deceleration table.

20. The method of claim 11 further comprising controlling the powertrain in response to the lift input.
